(19) United States
(12) Patent Application Publication
(10) Pub. No.: US 2021/0317862 A1
(43) Pub. Date: Oct. 14, 2021

(54) Self-Sealing Fastener and Collated Strips Thereof for Integrated Sheathing

(71) Applicant: OMG, Inc., Agawam, MA (US)

(72) Inventors: Timothy F. Gillis, Florence, MA (US); Mark J. Guthrie, West Springfield, MA (US); Mark A. Dicaire, Boylston, MA (US); R. Timothy Irwin, Lenox, MA (US); Peter Barenski, JR., Stockbridge, MA (US); Jonathan W. Dezielle, Agawam, MA (US); Arun Srlnivasan Venkatesan, Feeding Hills, MA (US)

(21) Appl. No.: 17/269,783

(22) PCT Filed: Aug. 21, 2019
(86) PCT No.: PCT/US2019/047436

§ 371 Date: Feb. 19, 2021

Related U.S. Application Data
(60) Provisional application No. 62/721,207, filed on Aug. 22, 2018.

(51) Int. Cl. F16B 33/00; F16B 15/08

(52) U.S. Cl. CPC F16B 33/004; F16B 15/08

(57) ABSTRACT

A self-sealing fastener for sheathing having an integrated water and air resistant barrier employs an activatable sealant which is disposed in a non-activated state on the fastener. Upon driving the fastener into the sheathing, the sealant activates and forms a seal at the fastener/sheathing interface and also functions as a shock absorber to prevent overdriving of the fastener. The sealant may take numerous forms including a deformable gasket, a collar and a washer. In some embodiments, up activation, the sealant exhibits a tint which contrasts with the tint of the sheathing. Collated self-sealing fastener strips or cartridges of various forms provide a matrix of severable fasteners each having a sealant which are sequentially drivable by an automatic driver.

### BACKGROUND

This disclosure relates generally to fasteners for attaching sheathing to a building frame or to structural studs. More particularly, this disclosure relates to fasteners for securing integrated sheathing having an air and water barrier.

In traditional wall construction, sheathing is fastened to the studs of the framework forming the wall support. Wrapping in the form of tar paper and/or other materials to control air leakage and water intrusion are wrapped over the installed sheathing. The wrapping is typically taped. Exterior wall claddings in the form of various materials such as wood shingles, metal siding, lap siding, hard cut stucco, brick and adhered stone are then applied to the exteriorly wrapped covered sheathing.

A new approach to construction has the potential for eliminating a step in the process by employing a sheathing which is integrated with a layer to form a built-in water-resistant barrier and an air-barrier. The integrated sheathing thus forms a thermal or environmental barrier without additional wrapping. For example, in one system known as the ZIP System™ of Huber Engineered Woods LLC, a ZIP System™ sheathing panel involves OSB board with an insulated layer of polyisocyanurate continuous foam insulation layer. The integrated sheathing is attached to the studs with the insulation layer engaging against the studs. Power drivers with automatic feed mechanisms are conventionally employed to drive fasteners which secure the sheathing to the studs. The adjacent integrated sheathing panels are taped. The integrated sheathing forms a thermal barrier which complies with applicable building codes.

Wall cladding of various forms is then attached to cover the exterior surface of the sheathing. The step of sheathing wrapping is essentially eliminated while providing structural integrity and thermal compliance that satisfies relevant building codes.

A potential issue with the integrated sheathing technology may arise from the fastener/integrated sheathing interface since, upon driving, the fastener penetrates the barrier material of the integrated sheathing and thus provides a potential barrier breach. The potential is exacerbated by the multiplicity of fasteners driven into each panel. In addition, overdriving the fastener can compromise the barrier integrity of the integrated sheathing.

### SUMMARY

Briefly stated, a self-sealing fastener for sheathing having an integrated water and air resistant barrier (“integrated sheathing”) comprises a fastener having a head and a shank extending from the head. An activatable sealant is disposed in a non-activated state on the fastener. Upon driving the fastener into the sheathing, the sealant activates and seals between the head and shank and an interface between the fastener and the sheathing and expands radially beyond the head.

Upon activation, the sealant has a first tint and the sheathing has an exterior surface with a second tint, and the sheathing tint and the fastener tint exhibit contrasting colors. The sealant in the non-activated form is configured in a collar ring about the shank. In one embodiment, in the non-activated form the sealant is applied to the head and may have a quasi-crown-like configuration in the non-activated form. The fastener may be a threaded fastener or a nail.

A self-sealing fastener for integrated sheathing comprises a fastener having a head and a shank extending from the head. An activatable sealant is disposed on or adjacent the head. Upon driving the fastener into the sheathing, the sealant activates and forms a seal at a fastener/sheathing interface and is compressed by the head and expands radially beyond the head. Upon activation, the sealant has a first tint and the exterior surface of the sheathing has a second tint, and the first and second tints are different.

A collated strip of self-sealing fasteners for integrated sheathing comprises a multiplicity of fasteners each having a head and a shank extending from the head and disposed in a linear array. A connector web connects the fasteners and is adapted so that a fastener is sequentially severable from the connector web as it is being driven. A sealant is disposed on at least some of the fasteners. The sealant is compressible and is radially extendable beyond the head.

In one embodiment, the connector web is disposed for engaging about each shank at an intermediate location spaced from the head, and the connector web is at least partially composed of a sealant. The connector web preferably comprises a series of substantially identical collars and severable bridges. Each fastener is drivable so that the fastener is severable from the strip of fasteners and the sealant is displaceable along the shank to engage against an underside of the head as the fastener is driven. In one embodiment, the sealant comprises two opposed sections which surround each of the shanks and are joined together.

In one embodiment, the connector web is disposed about the heads and is composed of a sealant and comprises a series of severable bridges connecting between the fasteners. Upon activation, the sealant has a first tint and the sheathing has an exterior surface with a second tint, and the sheathing tint and the fastener tint exhibit contrasting colors.

A collated strip of self-sealing fasteners for integrated sheathing comprises a multiplicity of fasteners each having a head and a shank extending from the head and disposed in a linear array. A connector web connects the fasteners and is adapted so that a fastener is sequentially severable from the connector web as it is being driven. A sealant carried by the connector is compressible and is radially extendable beyond the head.

The connector web is configured and disposed for engaging about each shank at an intermediate portion of the shank. A fastener is drivable so that a fastener is severable from the strip of fasteners and a sealant is displaceable along the shank to engage against an underside of the head as the fastener is driven. The sealant functions as a shock absorber and a seal between the fastener and the integrated sheathing.

### BRIEF DESCRIPTION OF THE DRAWINGS

FIG. 1 is a schematic view of a representative vertical wall employing integrated sheathing;

FIG. 2 is a perspective view of a representative integrated sheathing panel;

FIG. 3 is an elevational perspective view of a fastener for the integrated sheathing of FIG. 1 and having an activatable sealant;

FIG. 4 is a sectional view (slightly exaggerated) of the fastener as installed to secure the integrated sheathing of FIG. 2;

FIG. 5 is a side elevational view of a representative frontal fastener/sheathing panel interface for the fastener of FIG. 3;

FIG. 6A is a perspective view, partly in phantom, of a second embodiment of an integrated sheathing fastener having an activatable sealant;

FIG. 6B is a sectional view (slightly exaggerated) of the fastener (truncated in length) of FIG. 6A as installed for fastening an integrated sheathing panel (partially illustrated);

FIG. 7A is an elevational view of a third embodiment of an integrated sheathing fastener having an activatable sealant;

FIG. 7B is an enlarged sectional view of the fastener of FIG. 7A as installed for fastening an integrated sheathing panel (partially illustrated);

FIG. 7C is an enlarged frontal view of the installed fastener and panel of FIG. 7B annotated to show a tint contrast feature thereof;

FIG. 8 is a perspective view of a collated strip of self-sealing fasteners;

FIG. 9 is a perspective view of a second collated strip embodiment of self-sealing fasteners;

FIG. 10 is a schematic perspective view illustrating a manufacturing process for the collated strip of FIG. 9;

FIG. 11 is a perspective diagrammatic view of a third collated strip embodiment of self-sealing fasteners; and

FIG. 12 is a perspective view of a fourth collated strip embodiment of self-sealing fasteners.

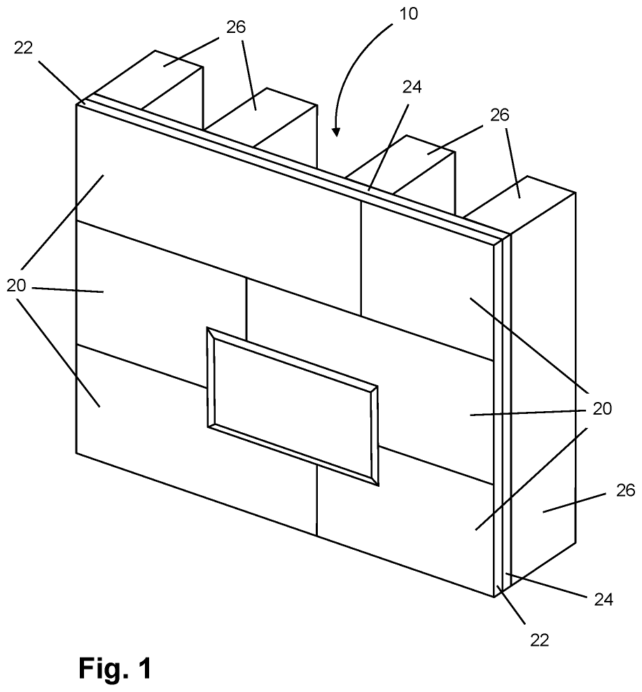

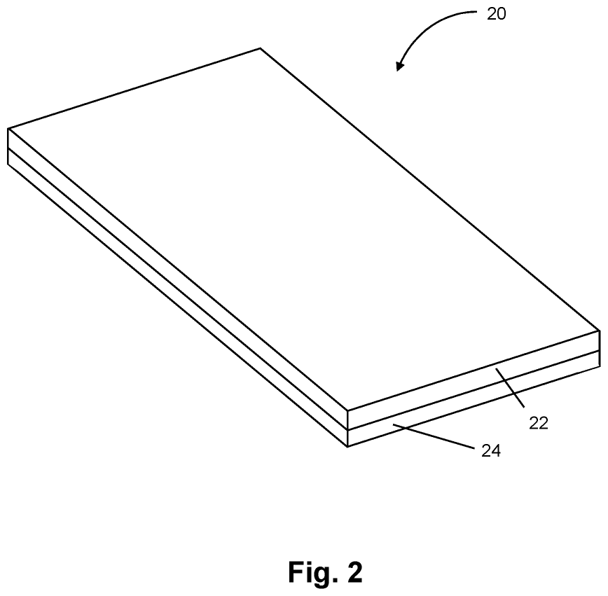

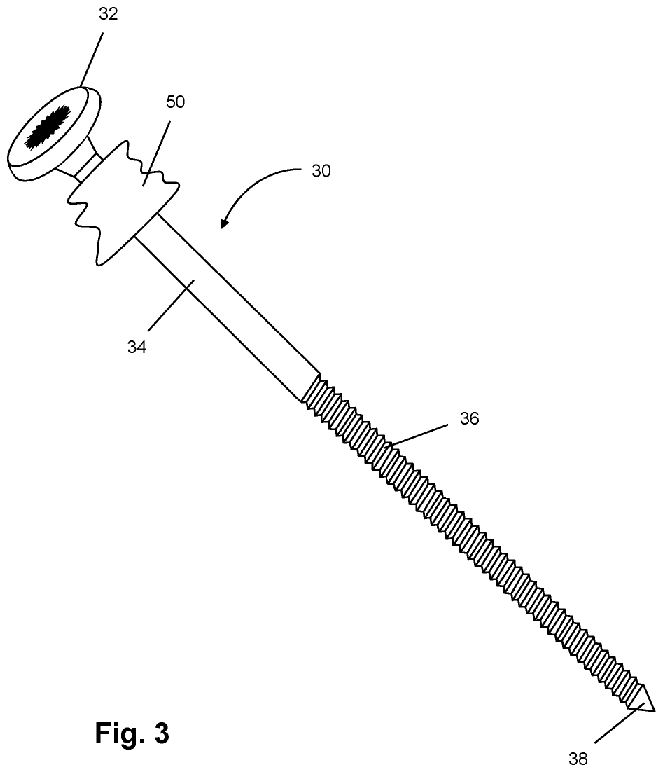

### DETAILED DESCRIPTION

With reference to the drawings wherein like numerals represent like parts throughout the figures, a representative partially constructed vertical wall is generally represented by the numeral 10. The wall comprises a multiplicity of integrated sheathing panels 20 (of various shapes and dimensions) which are fastened to the studs 26 of the frame support. The sheathing is fastened to the studs by self-sealing fasteners 30 and/or 40 and/or 60, which will be described below.

The integrated sheathing panel 20 comprises a layer of OSB board 22 or similar material and an attached layer 24 of insulation material which functions both as a water barrier and an air-barrier. Layer 24 engages against the studs 26 and functions to provide a built-in water-resistant barrier and an air-barrier. The integrated sheathing panel 20 itself also provides sufficient structural stability for the wall.

### Self-Sealing Fasteners

Self-sealing fastener 30 comprises a sheathing fastener such as HeadLok™ panel fastener of OMG, Inc., of Agawam, Mass. Fastener 30 has a head 32, a shank 34 and a thread 36 disposed about the shank. The thread may 36 extend to a gimlet tip 38.

As described herein, various sealants are described with various configurations and compositions which are transformed from a non-activated to an activated state upon driving or installing the fastener. The activated state of the sealant may take the form of a radical displacement of the initial non-activated sealant shape, may cause a compositional transformation due to the heat generated by the driving of the fastener and/or may cause a significant transformation of the sealant topography in the activated state. In this regard, it is highly desirable that the sealant functions not only as a malleable fluidic sealant at the interface of the head/fastener/shank and the integrated sheathing, but also functions to partially compress to provide a shock absorbent function at the underside of the head to prevent excessive overdriving or penetrating of the fastener and, in particular, the fastener head. The activated sealant also concurrently spreads radially outward beyond the fastener head so that it is visible upon driving the fastener.

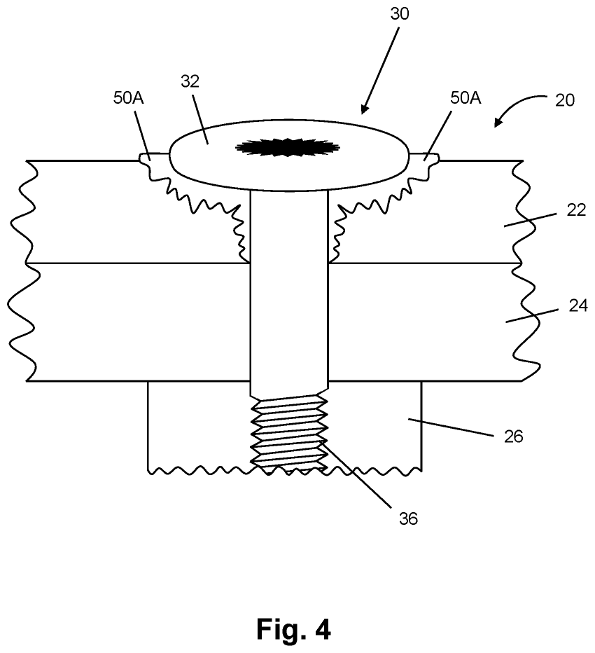

In one embodiment, a gel-like sealant 50 is mounted to an upper portion of the shank 34 prior to installation. The sealant 50 is configured as an irregular collar or ring circumferentially extending about the shank 34 adjacent the head 32. The sealant is initially effectively non-activated. Upon driving the fastener into the sheathing to fasten the sheathing to the stud, the sealant is activated by the heat of the driving force and the stress applied to the sealant to activate the sealant which transforms to an amorphous or quasi-amorphous form. The activated sealant designated as sealant 50A spreads against the underside of the head 32 and the upper portion of the shank to seal the head/shank/sheathing interface, as best shown in FIG. 4.

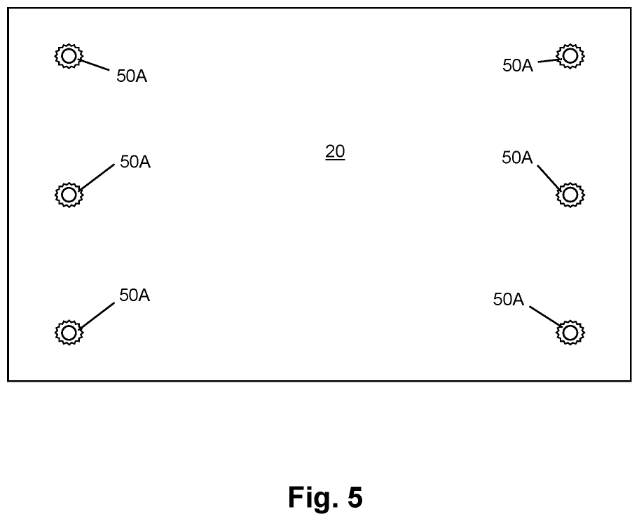

With reference to FIG. 5, a portion of the sealant 50A extends beyond the head at the face of the sheathing. The actuated sealant 50A has a tint which is different from the tint of the sheathing so that the fastener may be easily located and identified by an inspector and/or the craftsman during the construction process. For example, the ZIP System™ or sheathing product typically has a green exterior. Consequently, the tint of the sealant, upon activation, would be a tint, such as black, red or yellow, which has a dramatic contrast with the exterior green tint.

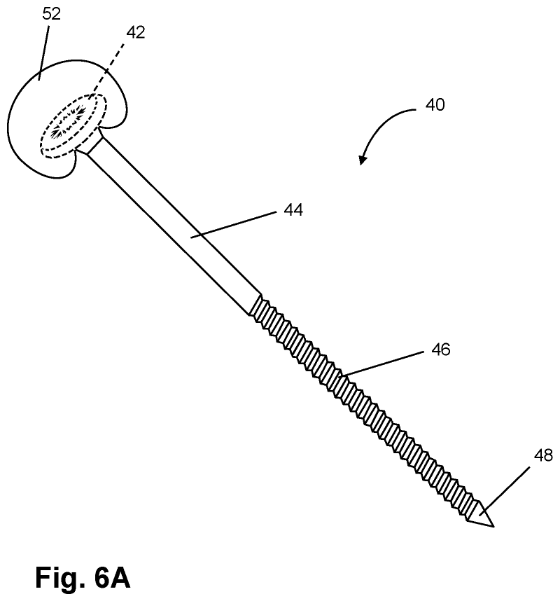

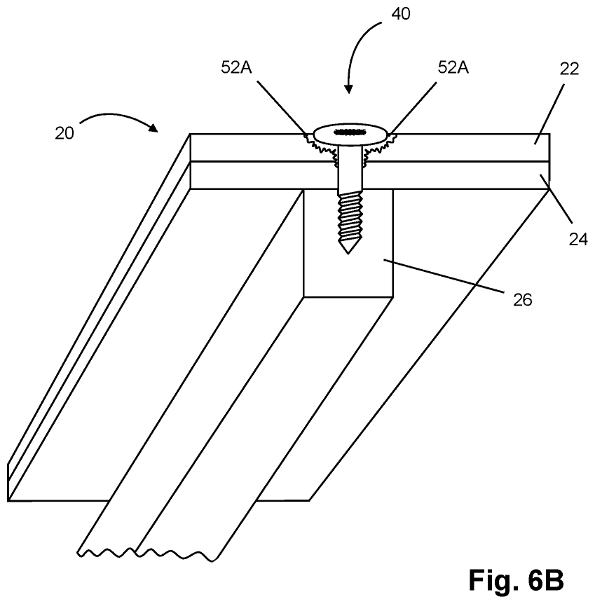

With reference to FIGS. 6A and 6B, self-sealing fastener 40 may also be a sheathing fastener similar in form and function to self-sealing fastener 30 except for the sealant. Self-sealing fastener 40 has a head 42, a shank 44 and a thread 46 and preferably terminates in a gimlet tip 48. A suitable base fastener for self-sealing fastener 40 is OMG product HeadLok™ panel fastener. Other fasteners are possible. A gel-like sealant 52 for fastener 40 is applied in a non-activated form on top of and around the head 42 to form a crown. Upon driving the self-sealing fastener 40 into the integrated sheathing, the sealant is activated (designated as 52A) to form a seal surrounding the head and the engaging interface with the sheathing 20. The tint of the actuated sealant 52A also preferably contrasts with the tint of the sheathing exterior surface so that the fastener 40 may be easily identified and located.

For some embodiments, the fasteners may be in the form of a nail and not a screw or a threaded member. In the nail embodiment, the activatable sealant is disposed in a non-activated state at the head of the nail and/or about the shank or at the underside of the head.

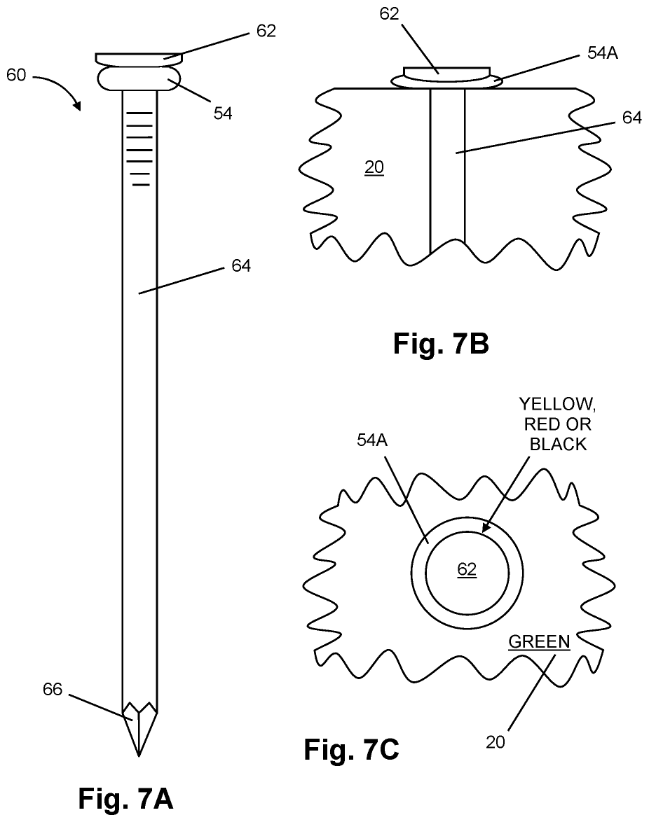

With reference to FIGS. 7A and 7B, self-sealing fastener 60 is in the form of a nail having a head 62 and a shank 64 extending to a pointed tip 66. Sealant 54 is configured as an annular sealing gasket surrounding the shank at the underside of the fastener head 62. The sealant 54 in the form of a gasket may be characterized as having a bulbous, annular or donut shaped configuration in the non-activated state. In the activated state, designated as 54A illustrated in FIG. 7B, the topography of sealant 54 is transformed so that portions of the sealant are radially outwardly displaced to circumferentially surround the underside of the head 62, and central portions of the sealant are compressed between the head 62 and the outer adjacent surface of the integrated sheathing 20.

Sealant 54 may be formed from rubber and similar compositions and may be affixed with a surface adhesive to secure it in position. Sealant 54 is also tinted so that upon driving the fastener, the sealant 54B has a tint which contrasts with the tint of the sheathing as illustrated in FIG. 7C.

### Multi-Sealable Fastener Collated Strips

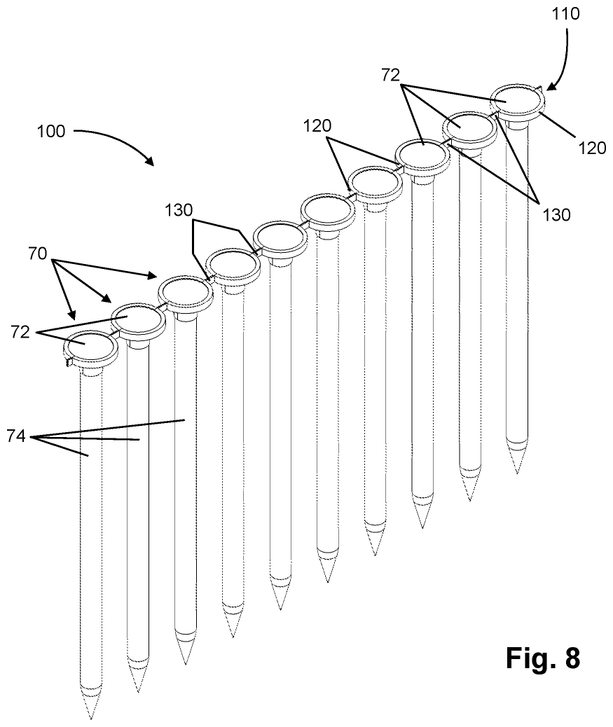

For power fastener drivers which employ schematic feed mechanisms, it is desirable that multiple fasteners be ganged in a collated strip or be loaded into a cartridge or web to form a matrix of fasteners. Various embodiments of representative collated strips of self-sealing fasteners are illustrated in FIGS. 8-15. The number of fasteners depicted is merely suggestive and numerous additional fasteners in accordance with the disclosure may be employed.

With reference to FIG. 8, a strip of self-sealing fasteners 70 is generally designated by the numeral 100. The depicted self-sealing fasteners 70 are nails having a head 72 and an extending shank 74 and are substantially identical. The self-sealing fasteners 70 are disposed in aligned side-by-side relationship and are connected by a band or web 110 which, for each self-sealing fastener 70, includes a collar 120 and an integral severable bridge 130 connecting each of the respective collars. Each collar 120 circumferentially surrounds the head 72 and covers the head underside and preferably extends about the upper portion of the shank 74. Each bridge 130 is configured to separate along a medial location as the fasteners are driven in an automatic driver.

Upon sequentially driving the fasteners 70, each collar 120 is forced against the underside of the head. The connecting web 110, and in particular, each collar 120, is at least partially formed of a sealant material. The web 110 may carry the sealant or the sealant may be heterogeneously dispersed throughout the web. As each self-sealing fastener 70 is sequentially driven, the underside of the head 72 compressively engages the sealant which functions to provide a seal against the head/nail/shank interface. In addition, the separated collar 120 functions as a shock absorber to prevent overdriving of the nail.

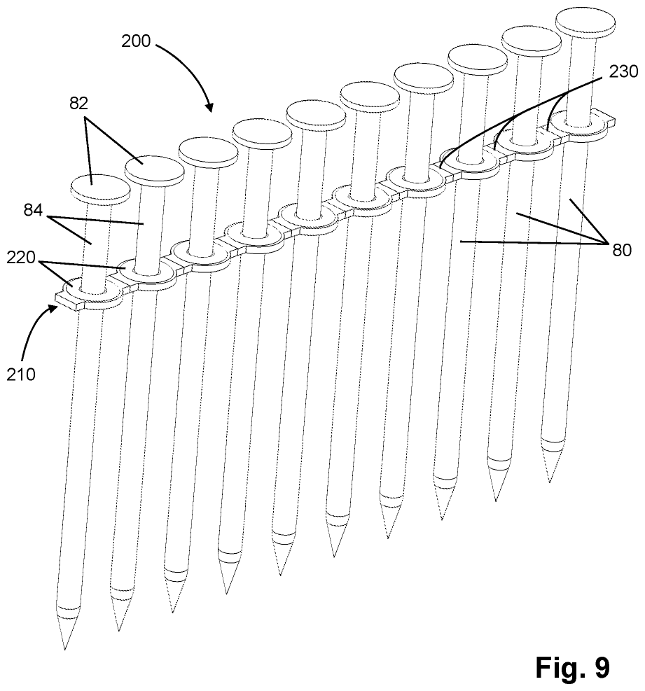

With reference to FIG. 9, a collated strip of self-sealing fasteners 80 is generally designated by the numeral 200 and comprises a linear array of substantially identical self-sealing fasteners 80 with a head 82 and a shank 84. The self-sealing fasteners 80 are connected by a strip-like web 210 comprising a series of substantially identical washer-like sealing elements 220. Each sealing element 220 circumferentially surrounds the shank 84 at an intermediate shank location spaced from the head 82.

Each of the sealing elements 220 connects with the succeeding adjacent component by a narrow bridge or tab 230. The tabs 230 are sufficient to connect the self-sealing fasteners in a non-activated state, but when the fastener is driven, the connector tabs 230 are sequentially severed. Each sealing element 220 is ultimately forced along the shank to engage around the underside and periphery of each head 82 of the fastener. The integrated web connecting structure comprising the tabs and the collars is at least partially composed of a sealant material which functions to seal the fastener at the head/shank interface as well as also to provide a shock absorbing function as the fastener is driven to inhibit overdriving.

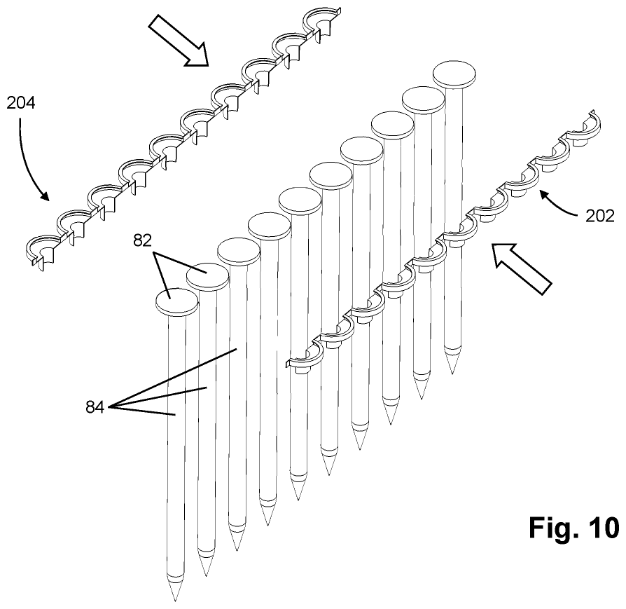

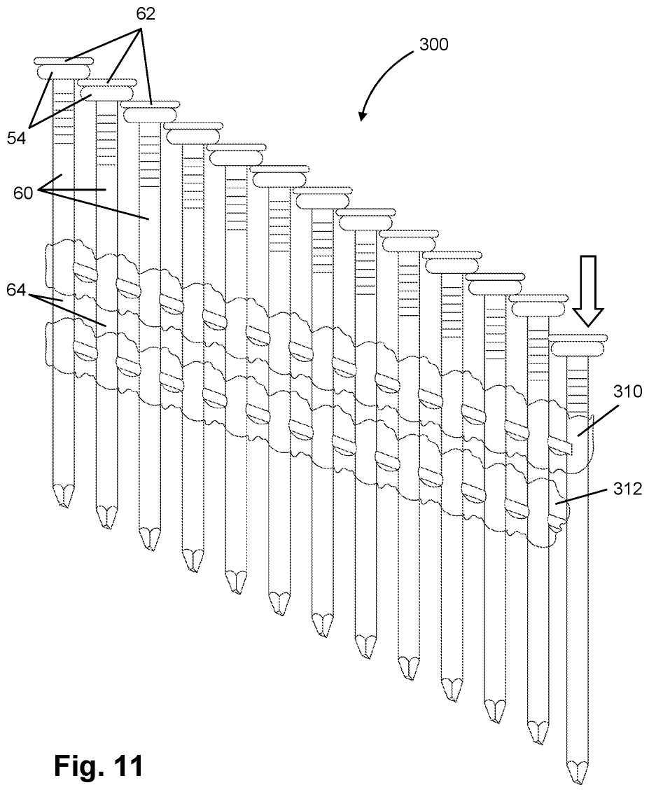

With reference to FIG. 10, the connecting sealing structure of the web 210 of self-sealing fasteners 80 may be affixed to the fastener shanks 84 by providing substantially identical molded segments 202 and 204. The segments are forced together at opposed sides of the fastener shank 84 and connected together by a snap fit engagement, by one or more clips, by adhesive or by a heat process to integrally join the two halves to provide an integrated structure, for example web 210, as illustrated in FIG. 9. The integrated structure of web 210 functions as both a fastener strip connector and sealant for the collated strip 200 of self-sealing fasteners.

With reference to FIG. 11, a collated strip of self-sealing fasteners is designated by the numeral 300. The self-sealing fasteners 60 each have a separate sealant gasket 54 disposed at the underside of the head 62. The fasteners 60 are arranged in stepped fashion. The fasteners are connected by a pair of conformal translucent plastic retainers 310 and 312 spaced along the shanks 64. The retainers 310 engage about the fastener shanks 64. The retainers incrementally break away as representatively shown by retainer 312 when the fastener is driven.

In one preferred embodiment, at a given interval, the nth self-sealing fastener in the cartridge or collated strip does not have the sealing gasket or any sealant so that the automatic driver can clear any sealant material from the driver at periodic intervals.

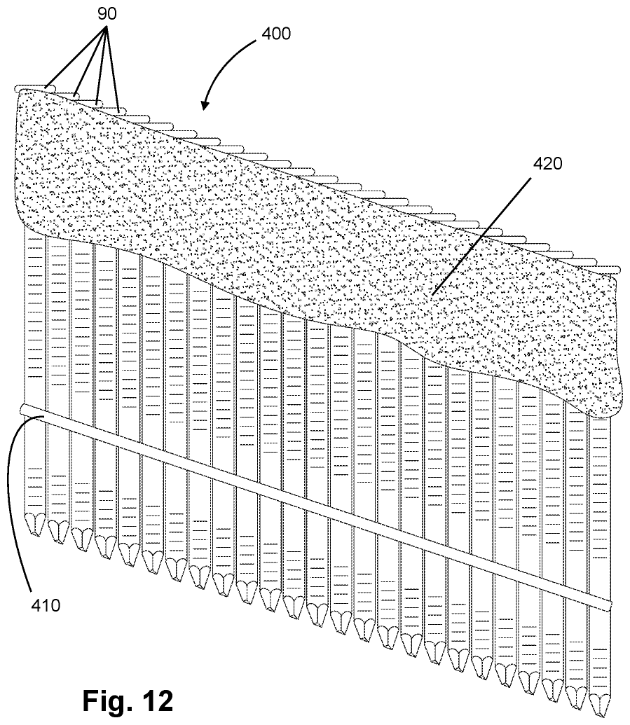

With reference to FIG. 12, a collated strip of self-sealing fasteners is designated by the numeral 400. The fasteners 90 may be collated together by a band-like web 410 which is incrementally severable as each fastener is driven to form a cartridge. The upper portions of the fasteners 90 are sprayed with or covered by a sealant material 420. The sealant material 420 forms an integrated mass which binds the fasteners together and separates into a discrete sealing segment which clings to the fastener as each fastener is sequentially driven by the driver. In one preferred application, the sealant material 420 is a 3M™ Fire Barrier Sealant FD150⁺.

The described self-sealing fasteners with an activatable sealant are not limited to fastening sheathing, but may be employed in a wide variety of construction fastening applications. They may also be employed in systems which involve OSB board without an insulation layer that is affixed with a green or another moisture barrier or wherein a thermal/moisture barrier is subsequently applied prior to driving the fasteners. The fasteners may be driven into any form of construction material and activated to form a seal at the fastener interface with the material.

It should be appreciated that the disclosed fasteners, whether they be in the form of screws or nails with the activatable sealant as described, are less susceptible to being driven below the surface of the materials and are essentially self-sealing.

While preferred embodiments of the foregoing have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A self-sealing fastener for sheathing having an integrated water- and air-resistant barrier comprising:
a fastener having a head and a shank extending from said head;
an activatable sealant disposed in a non-activated state on said fastener;
whereupon driving said fastener into said sheathing, said sealant activates and seals at an interface between the fastener and the sheathing and expands radially beyond the head.

2. The self-sealing fastener of claim 1 wherein, upon activation, said sealant has a first tint and the sheathing has an exterior surface with a second tint and the sheathing tint and the fastener tint exhibit contrasting colors.

3. The self-sealing fastener of claim 1 wherein the sealant in the non-activated form is configured in a collar or ring about the shank.

4. The self-sealing fastener of claim 1 wherein the sealant in the non-activated form is applied to the head.

5. The self-sealing fastener of claim 4 wherein the sealant in the non-activated form has a quasi-crown-like configuration.

6. The self-sealing fastener of claim 1 wherein the fastener is a threaded fastener or a nail.

7. A self-sealing fastener for a sheathing having an integrated water- and air-resistant barrier comprising:
a fastener having a head and a shank extending from said head;
an activatable sealant disposed on or adjacent said head,
whereupon driving said fastener into said sheathing, said sealant activates and forms a seal at a fastener/sheathing interface and is compressed by the head and spreads radially beyond the head.

8. The self-sealing fastener of claim 7 wherein, upon activation, said sealant has a first tint and the exterior surface of the sheathing has a second tint and the first and second tints are different.

9. The self-sealing fastener of claim 8 wherein the fastener is a threaded fastener or a nail.

10. A collated strip of self-sealing fasteners for integrated sheathing comprising:
a multiplicity of fasteners each having a head and a shank extending from said head and disposed in a linear array;
a connector web connecting said fasteners and adapted so that a fastener is sequentially severable from said connector as it is being driven; and
a sealant disposed on at least some of said fasteners, said sealant being compressible and being radially extendable beyond said head.

11. The collated self-sealing fastener strip of claim 10 wherein said connector web is disposed for engaging about each said shank and said connector web is at least partially composed of a sealant.

12. The collated self-sealing fastener strip of claim 11 wherein said connector web comprises a series of substantially identical collars and severable bridges.

13. The collated self-sealing fastener strip of claim 12 wherein a fastener is drivable so that said fastener is severable from the strip of fasteners and said sealant is displaceable along said shank to engage against an underside of said head as the fastener is driven.

14. The collated self-sealing fastener strip of claim 11 wherein said sealant comprises two sections which surround each of said shanks and are joined together.

15. The collated self-sealing fastener strip of claim 10 wherein said connector web is disposed about said heads and is composed of a sealant and comprises a series of severable bridges connecting between said fasteners

16. The self-sealing fastener of claim 10 wherein, upon activation, said sealant has a first tint and the sheathing has an exterior surface with a second tint, and the sheathing tint and the fastener tint exhibit contrasting colors.

17. A collated strip of self-sealing fasteners for integrated sheathing comprising:
a multiplicity of fasteners each having a head and a shank extending from said head;
a connector web connecting said fasteners to form a linear array of fasteners and adapted so that a fastener is sequentially severable from said connector web as it is being driven; and
a sealant carried by said connector, said sealant being compressible and being radially extendable beyond said head.

18. The collated self-sealing fastener strip of claim 17 wherein said connector web is configured and disposed for engaging about each said shank at an intermediate portion of said shank.

19. The collated self-sealing fastener strip of claim 17 wherein a fastener is drivable so that a said fastener is severable from the connector web and a said sealant is displaceable along a said shank to engage against an underside of a said head as the fastener is driven.

20. The collated self-sealing fastener strip of claim 11 wherein said connector web comprises two opposed sections which surround each of said shanks and are joined together.
